(19) United States
(12) Patent Application Publication
(10) Pub. No.: US 2014/0149221 A1
(43) Pub. Date: May 29, 2014

(54) SYSTEM AND METHOD FOR BILLBOARD CONTROL

(71) Applicant: Cirrus Systems, Inc., San Rafael, CA (US)

(72) Inventor: Stephen David Rycyna, III, San Rafael, CA (US)

(73) Assignee: Cirrus Systems, Inc., San Rafael, CA (US)

(21) Appl. No.: 14/092,422

(22) Filed: Nov. 27, 2013

Related U.S. Application Data
(60) Provisional application No. 61/731,142, filed on Nov. 29, 2012.

(51) Int. Cl. G06Q 30/02

(52) U.S. Cl. CPC G06Q 30/0264
USPC 705/14.61

(57) ABSTRACT

A method for scheduling content for a digital billboard, including: receiving an advertisement schedule from a first user account, the schedule comprising advertisement media; identifying a billboard identifier associated with the user account, the billboard identifier associated with the billboard; controlling the billboard to display the advertisement media according to the advertisement schedule; and in response to receipt of an application request for the billboard from a user device, the application request identifying an application associated with the user account, interrupting advertisement media display and directing control of the billboard to the application.

### CROSS-REFERENCE TO RELATED APPLICATIONS

This application claims the benefit of U.S. Provisional Application No. 61/731,142 filed 29 Nov. 2012, which is incorporated in its entirety by this reference.

### TECHNICAL FIELD

This invention relates generally to the digital billboard field, and more specifically to a new and useful billboard control and advertisement scheduling system and method in the digital billboard field.

### BRIEF DESCRIPTION OF THE FIGURES

FIG. 1 is a schematic representation of the method for digital billboard control.

FIG. 2 is a schematic representation of a variation of the system and method for digital billboard control.

FIG. 3 is an example of a user interface for receiving an advertising schedule from a user.

FIG. 4 is a schematic representation of a variation of processing advertisement and application media at a first and second billboard system.

FIGS. 5, 6, 7, 8, and 9 are schematic representations of variations of the method of digital billboard control.

FIGS. 10 and 11 are schematic representations of variations of the method of digital billboard control including input measurement collection.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

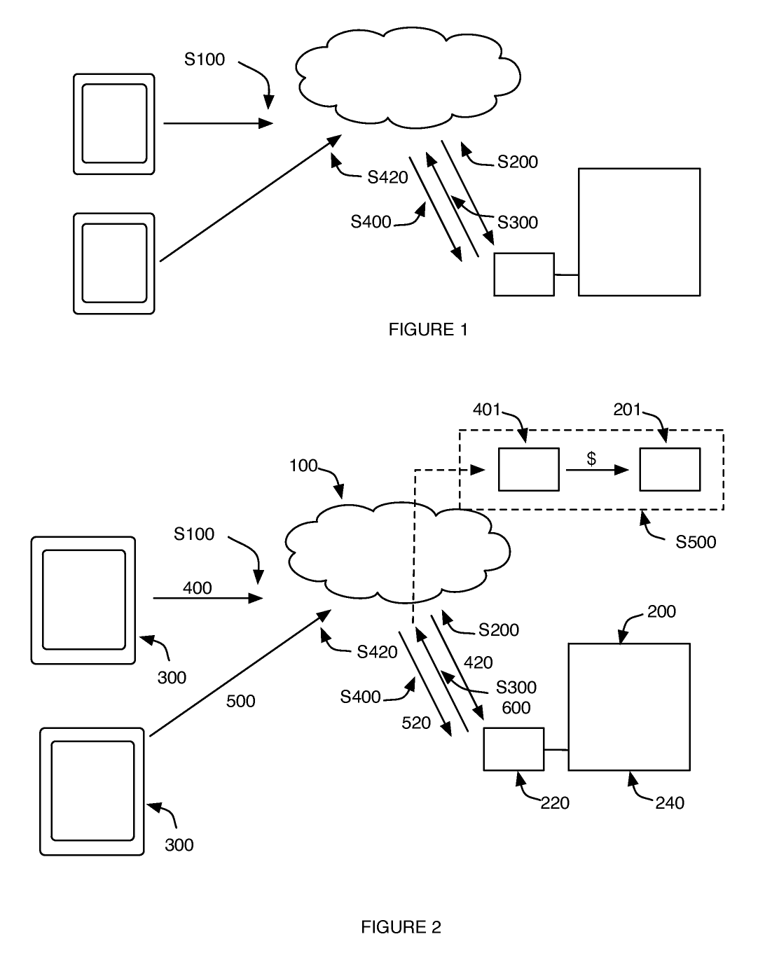

As shown in FIG. 1, the method of scheduling advertisements for a digital billboard includes receiving an advertising schedule from a user S100, controlling the digital billboard to display the scheduled advertisement media S200, tracking display metrics for each piece of advertisement media S300, and in response to receipt of an application control request identifying an application S420, facilitating billboard control through an application S400. This method can additionally track conversion parameters through billboard inputs, such as cameras, and dynamically adjust the advertisement schedule or pricing based on the conversion parameters.

This method functions to dynamically shift control of one or more digital billboards from automatic display of scheduled advertisements to real-time application display controlled by a user. This method can additionally function to determine the display instances of each advertisement and the amount of billboard use by a given user, and bill the respective parties accordingly. This method can additionally dynamically adjust the advertisement schedule or pricing for each time slot, which can function to increase conversion rates for the advertisements. The method can additionally dynamically coordinate an advertising campaign based on the billboard inputs. This method can additionally aggregate, process, and return conversion parameter data for each of the advertisements, and can provide recommendations to advertisers for the campaigns.

As shown in FIG. 2, this method is preferably used with a remote server system 100 connected to a digital billboard system 200, but can alternatively be used with any other suitable computing and display system. The remote server system preferably determines all the media for display on the digital billboard system, such that the processing load on the billboard processors is reduced. However, the method can alternatively be partially or wholly performed by the billboard processors.

The remote server system 100 functions to determine and control the content that is displayed on each digital billboard 200, but can alternatively function as a repository for the advertisement media and associated advertisement parameters. The remote server system preferably includes a plurality of networked servers, but can alternatively be a single server. The set of remote servers are preferably connected to the digital billboard system through an Internet connection, but can alternatively be connected to the digital billboard system through short-range communications (e.g., WiFi, RFID, etc.), long-range communications (e.g., cellular networks, satellite networks, etc.), or any suitable combination of communication systems. The communication is preferably wireless but can alternatively be wired. The servers are preferably stateful servers that maintain the state of each billboard, but can alternatively be stateless servers (e.g., wherein the billboard processors maintain the billboard state and pull information as needed from the servers), or a combination thereof. The remote server system 100 can function to receive the advertising schedule 400 from a user device 300 (e.g., the user device of the billboard owner, an authorized scheduling agent, etc.). The remote server system 100 can additionally receive, generate, and/or store advertisement media 420, application media 520, applications, the display record 600, the application user record, payment account information (e.g., for the advertiser account 401 and the billboard owner account 201, etc.), or any other suitable information. The remote server system 100 preferably controls the billboard system 200 between an advertising mode and an application mode. The remote server system 100 preferably switches one or more billboards of the billboard system 200 from the advertising mode to the application mode in response to receipt of an application control request 500 received from a user (e.g., a second user different from the billboard owner, the billboard owner, etc.).

The billboard system 200 functions to display advertisement and application media. The billboard system preferably includes a set of digital billboards (e.g., one or more billboards) that are connected to the remote server system. Each billboard is preferably uniquely identified by a billboard identifier stored within the remote server system. The remote server system can additionally store billboard parameters, such as the user account(s) associated with the billboard (e.g., the billboard administrators or owners), billboard dimensions, age, connected billboard inputs 260 (e.g., capabilities), location, or any other suitable parameter. The set of digital billboards can be owned by a single entity having a user account on the remote server system, or different subsets of the billboard set can be owned by different entities, each having a different user account on the remote server system. Each billboard of the billboard system preferably includes a display 240 connected to a processor 220. The display is preferably a modular display, and is preferably formed from multiple substantially identical display units. However, the display can be a single display unit or have any other suitable configuration. The display is preferably an LED display, but can alternatively be any other suitable display technology. The display units are preferably wired together, but can alternatively be wirelessly connected. The display units are preferably connected in series, but can alternatively be connected in parallel. The processor preferably functions to control the media that is presented on the display. The processor preferably receives display media from the remote server system, and controls the display to present the display media. The display media is preferably pre-formatted by the remote server system for the specific billboard, but the processor can alternatively format the display media into a form suitable for presentation on the respective display. Additionally or alternatively, the processor can receive display instructions for one or more of the advertisements, wherein the processor can generate the display media. The processor can additionally retrieves requisite information for an advertisement from one or more remote server systems. The processor can additionally create a display record 520 by recording the display instances for each of the advertisements and send the display record to the remote server system. The processor can additionally receive billboard input measurements from billboard inputs, and can send the record of billboard input measurements to the server. The processor can additionally correlate the billboard input measurements with an identifier for the concurrently shown advertisement. The processor can additionally process the billboard input measurements to extract conversion parameters, and can send the resultant conversion parameter record to the remote server system. The processor can additionally selectively control billboard input operation based on input instructions associated with an advertisement or application. For example, the processor can turn on a billboard camera in response to a scheduled interactive advertisement, or turn on a transmitter/receiver pair that wirelessly communicates with a user device in response to receipt of an application control notification from the server.

The billboard system can additionally include one or more billboard inputs. The billboard inputs preferably function to collect and/or measure parameters for advertisement or application interaction and/or conversion parameter determination. Each billboard can include one or more billboard inputs of the same or of varying types. Alternatively, the billboard inputs can be decoupled from the billboard. The billboard input is preferably arranged on the billboard display, but can alternatively be incorporated into the processor. Examples of billboard inputs include a camera, a Bluetooth transmitter/receiver, an RFID transmitter/receiver, a touchscreen, a temperature sensor, light sensor, or any other suitable type of sensor.

As shown in FIG. 1, receiving an advertising schedule from a user S100 functions to determine an advertisement schedule for a billboard. Receiving an advertising schedule preferably includes determining one or more advertisements, determining an advertising schedule, and assigning the advertisements to the billboard identifier.

Determining one or more advertisements functions to store advertisements at the remote server system or the billboard. The advertisements can be uploaded by the user, received or retrieved from a second server system (e.g., through a URI or any other suitable identifier), created within the system by the user, or generated in real-time by the system (e.g., the server system or billboard system) based on a set of advertisement instructions. The user is preferably the billboard system owner, but can alternatively be an advertiser or any other suitable user.

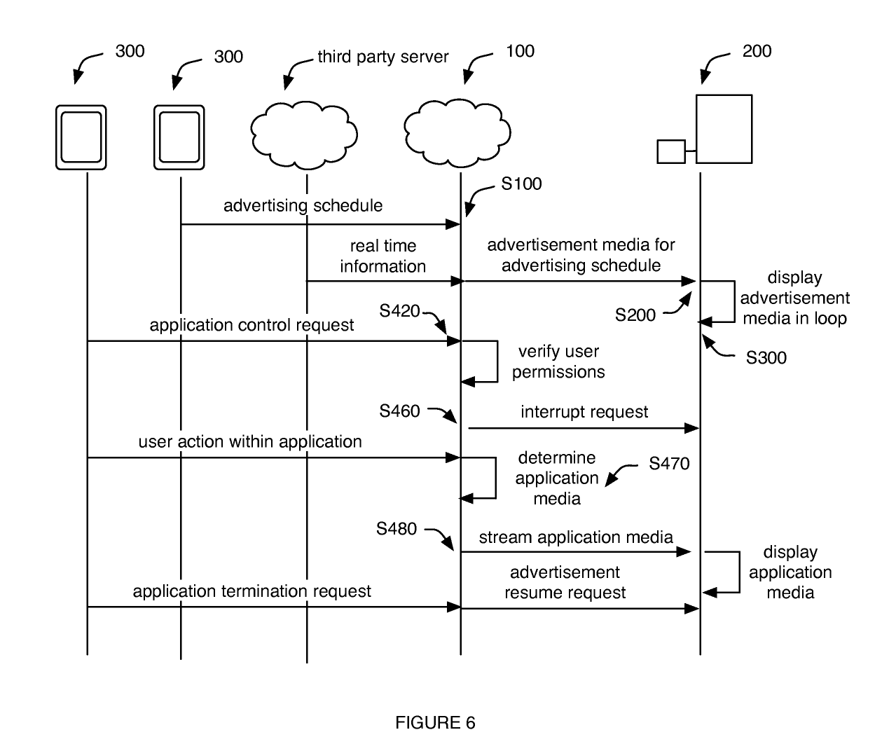

In one variation of creating the advertisement, the advertisement can include a set of instructions (e.g., an advertisement application) to retrieve information from a third party server system when the advertisement is to be displayed, as shown in FIG. 6. The set of instructions preferably instructs the server or the processor to access the third party server and to retrieve information through an API, but can alternatively instruct the server or processor to retrieve information in any other suitable manner. The information is preferably retrieved in real-time, but can alternatively be retrieved upon advertisement creation and stored by the server system. For example, the set of instructions can instruct the server to retrieve the content stream for an account of a social networking system (e.g., a Twitter stream or a stream of Facebook wall posts) in real time, and to incorporate the content stream into the advertisement. The set of instructions can create the whole advertisement, or can import information to a portion of the advertisement. The set of instructions is preferably associated with the user account, wherein the user account has downloaded, purchased, or otherwise associated the set of instructions with the user account (e.g., from an application store). The set of instructions is preferably stored in association with the user account on the remote server system, but can alternatively be stored on the billboard processors associated with the user account (e.g., wherein the user can select which billboard processors store the set of instructions), be stored in association with the billboard identifiers associated with the user account, or be stored in any other suitable manner. The advertisement media can be generated in response to the substantially instantaneous time falling within a threshold time period from the time that the advertisement is to be shown (time assignment). When the advertisement is generated at the server, the generated advertisement is preferably sent to the processor prior to the time assignment.

Determining an advertisement can additionally include receiving advertisement parameters for the advertisement. The advertisement parameters can include distribution parameters, payment parameters, or any other suitable advertisement parameter. Distribution parameters can include the geographic location (e.g., area) in which the advertisement should be shown, the desired type of building in which the advertisement is to be shown (e.g., a mall, office building, etc.), the target demographic for the advertisement, the time period in which the advertisement should be shown (e.g., from March to April), the desired time slot or time range for advertisement display (e.g., between 10 AM to 6 PM, at 1:00 PM every day, etc.), the brightness level of the advertisement, the volume of the advertisement, the billboard inputs requirements for the advertisement, or any other suitable advertisement distribution or display parameter. Payment parameters can include the payment per advertisement display instance, the payment per display instance in a given geographic location, the payment per display time unit, the payment per view by a potential customer, the payment per view by a targeted customer, or the payment for any other suitable display metric. The payments can be a single payment value, tiered payments for different display metric levels (e.g., a first payment level for a first range of views, a second payment level for a second range of views, etc.), or any other suitable payment structure. For example, the payment per display instance can decrease with increased distance away from a desired geographic location (e.g., mall, office building, etc.)

Determining an advertisement can additionally include receiving an advertiser payment account identifier for the advertisement, wherein payments for displaying the advertisement can be transferred from the identified advertiser payment account to a payment account owned by the billboard owner or any other suitable user.

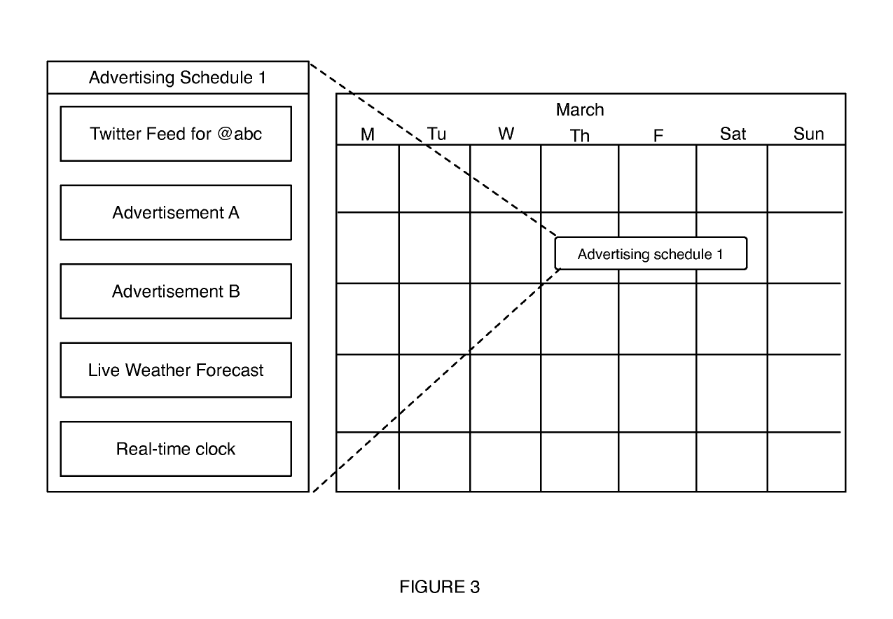

Determining an advertising schedule functions to determine an order for advertisement display. Determining an advertising schedule preferably includes receiving the advertising schedule from a user account, but can alternatively include automatically generating the advertising schedule based on the advertisement parameters associated with each advertisement, the billboard input measurements, or any other suitable parameter (e.g., time of day, month, season, current events, etc.). Receiving the advertising schedule from a user account preferably includes receiving an advertising schedule entry from a user account, but the advertising schedule can alternatively be uploaded to the system, retrieved from a second server system, or otherwise obtained. Receiving an advertising schedule entry from a user account can include displaying the advertisement or a representation of the advertisement (e.g., a name, frame, or any other suitable identifier) and receiving a time assignment, such as a timestamp or order assignment for the advertisement from the user. In one variation, the advertisement representation can be digitally dragged and dropped into a timeslot or a queue, as shown in FIG. 3. In another variation, a timestamp or order number can be entered in association with (e.g., next to) the advertisement. Each schedule of advertisements can additionally be assigned to a time period, such as a specific minute, hour, day, week, month, year, or any other suitable time period. The advertising schedules can be assigned to the time period by dragging and dropping a representation of the advertisement schedule into a calendar, by entering a time and/or date for the advertising schedule, or otherwise assigning the advertising schedule to a specific time period. Determining an advertising schedule can additionally include receiving schedule parameters for the advertising schedule. The schedule parameters can include the geographic location (e.g., area) in which the advertising schedule should be shown, the target demographic for the advertising schedule, the payment per advertising schedule run (e.g., a single payment value, a range of payment values, a set of payment values for different conversion rates, etc.), the brightness level of the advertisement, the volume of the advertisement, or any other suitable advertisement distribution or display metric.

Assigning the advertisements to a billboard identifier functions to determine which billboards will show the advertisements. In one variation of the method, assigning the advertisement schedule to a billboard preferably includes identifying a billboard identifier associated with a user account, displaying the billboard identifier to the user, and assigning the advertisements to the billboard identifier in response to selection of the billboard identifier. The user account is preferably the user account scheduling the advertisements, but can alternatively be any other suitable user account having advertisement assignment permissions for the billboard identifier. An advertising schedule can be simultaneously assigned to multiple billboard identifiers. A billboard identifier can be simultaneously assigned to multiple advertising schedules. The advertisement schedule is preferably assigned to the billboard identifier, but individual advertisements can alternatively be assigned to the billboard identifier. In another variation of the method, assigning the advertisement schedule to a billboard identifier includes automatically assigning an advertising schedule or individual advertisements to billboards based on the billboard parameters and the advertisement parameters. For example, the advertisement or advertising schedule can be automatically assigned to the billboard when a threshold number of advertisement parameters match the billboard parameters (e.g., when 50% of the advertisement parameters match the billboard parameters). In another variation of the method, billboard owners are presented advertisements having parameters that match the billboard parameters (e.g., beyond a threshold similarity), and can add the presented advertisements to the advertising schedule for the matched billboards.

Controlling billboard to display media S200 functions to present media at the selected billboard. The media is preferably advertisement media, and is preferably presented according to the advertising schedule. However, the media can be application media (e.g., media controlled by an application or executable on the server, a user device, or the processor), or be any other suitable media. The advertisement media is preferably displayed in response to a substantially instantaneous time coinciding with the time assignment for the scheduled advertisement application within a threshold time duration (e.g., wherein the instantaneous time is within 5 minutes or 5 seconds of the time assignment). The advertisement media can alternatively be displayed in the scheduled order, but can alternatively be displayed in any other suitable order.

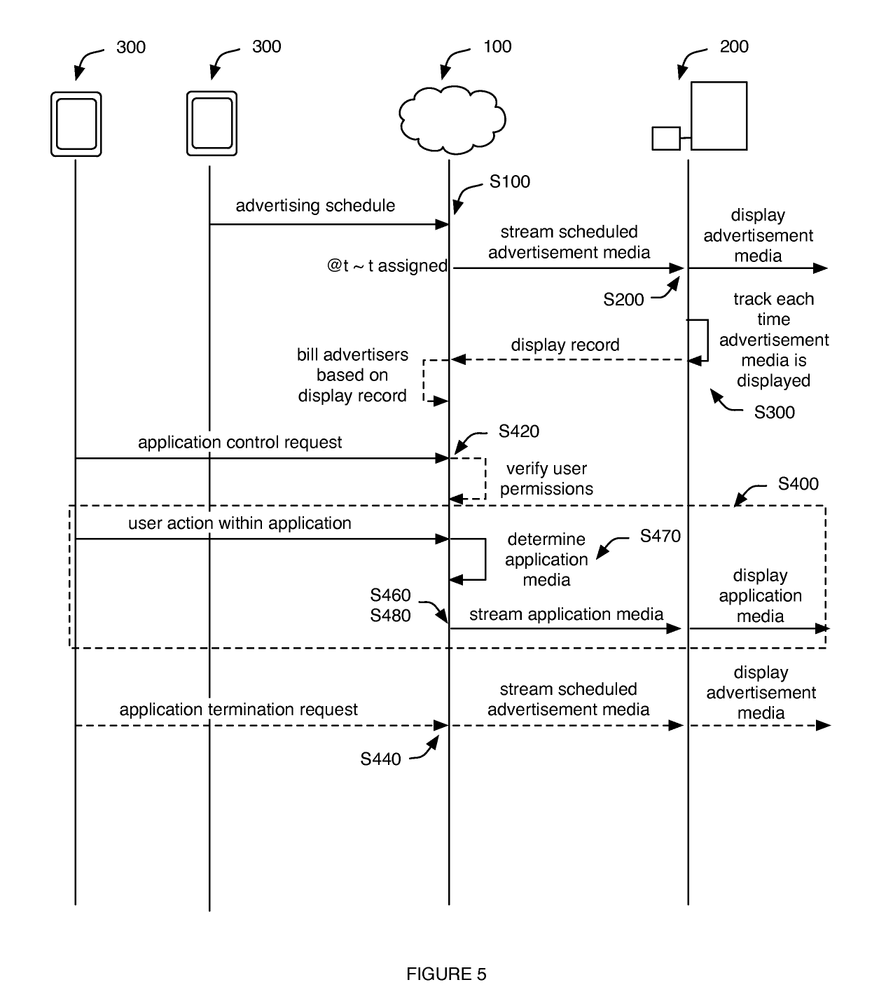

In one variation of the method, the billboard is controlled by the server, wherein the server determines the media to be presented and sends the media to the billboard, wherein the billboard presents (e.g., displays or plays) any media received from the server system. The server system preferably determines the advertisements to be shown based on the advertisement identifiers within the schedule, identifies the advertisement media corresponding to the advertisement identifiers or generates the advertisement media according to instructions corresponding to the advertisement identifiers, and sends the advertisement media to the billboard. The billboard preferably plays the advertisement media received from the server system. The server system preferably determines and sends the advertisement media in real time to the billboard processor (e.g., streams the advertisement media to the processor), as shown in FIG. 5, but can alternatively determine and send the advertisement media to the billboard, wherein the billboard loops the received advertisement media, as shown in FIG. 6.

In another variation of the method, the processor controls media display on the billboard. The processor preferably receives advertisement media and advertising schedule from the server, stores the advertisement media, and displays the advertisement media according to the advertising schedule. The server preferably sends the billboard advertisement media for a given time duration (e.g., 30 minutes worth of advertisement media), but can alternatively send media for given timestamp or time period (e.g., from 1:30 PM-2:30 PM, every day or on a specific date). When the advertisement media is for a given time duration (e.g., 10 minutes worth), the billboard preferably plays the advertisement media on repeat. When the advertisement media is for a given timestamp, the billboard preferably plays the advertisement media at the timestamp or during the time period. The server can send one set of advertisement media (e.g., all the advertisement media for one advertising schedule), a subset of the advertisement media for an advertising schedule, multiple sets of advertisement media (e.g., for multiple advertising schedules), or send any other suitable amount of advertisement media. The advertisement media is preferably sent for one time period, but can alternatively be sent for multiple time periods. The processor preferably requests advertisement media or advertising schedules from the server at a predetermined frequency (e.g., every 10 minutes, 1 hour, 1 day, 1 week, 1 month, etc.). Alternatively, the server can send the advertisement media or advertising schedules to the processor in response to receipt of new advertisement media or a new advertising schedule. In the variation of the method in which the advertisement is generated from real-time data or streamed data (e.g., media stored on a third party server, such as a video from YouTube), the processor can request the data from the server system when the advertisement is to be displayed (e.g., a predetermined time period before the advertisement is to be shown, etc.). Alternatively, the advertisement media sent to the processor can include instructions for data retrieval, wherein the processor retrieves the data from the third-party server, generates the advertisement media based on the data, and displays the generated advertisement media in substantially real time.

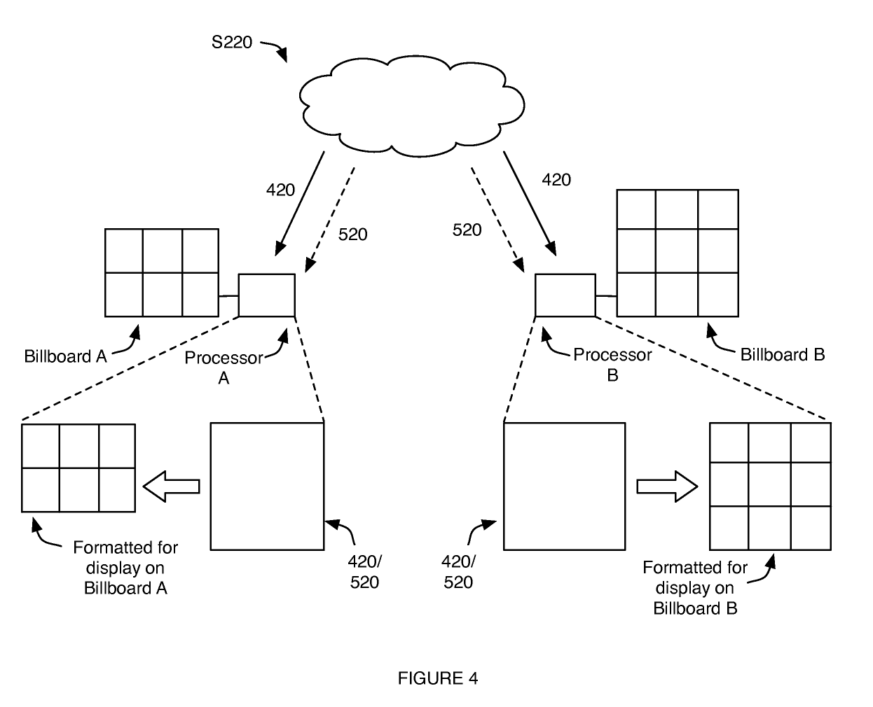

Controlling the billboard to display the advertisement media can additionally include processing the advertisement media S220, as shown in FIG. 4. Processing the advertisement media can include segmenting the visual media (e.g., video or images) into segments suitable for display on an individual display module and assigning an address to each segment to map the segments to the individual display modules that cooperatively form the display. Processing the advertisement media can additionally include reformatting the advertisement media (e.g., resizing, adjusting the resolution, adjusting the audio and lighting levels, etc.) to fit the billboard display. The server preferably processes the advertisement media, but the billboard processor can alternatively process the advertisement media.

Tracking display metrics for each piece of advertisement media S300 functions to determine which account to bill and what the payment amount should be. The display metrics are preferably tracked by the billboard processor, but can alternatively be tracked by the server. Tracking the display metrics for each piece of advertisement media preferably includes tracking each instance of advertisement media display (e.g., each time the advertisement is run), but can alternatively include tracking the amount of time that the advertisement media was displayed, where the advertisement media was displayed (e.g., the location of the billboard that the advertisement media was displayed on), or any other suitable advertisement serving parameter. When the billboard includes billboard inputs, tracking the display metrics of each piece of advertisement media can additionally include tracking the number of people passing by the billboard while the advertisement media was displayed (e.g., the number of people passing by during each instance of advertisement media display, the average number of people passing by during advertisement media display, etc.), tracking the number of people satisfying the target demographic of the advertisement, tracking the number of people who looked at the display while the advertisement was playing (e.g., by using conventional eye tracking methods), tracking the actions of people passing by the billboard while the advertisement was playing, or tracking any other suitable conversion parameter. Tracking the display metrics can additionally include simultaneously tracking the display metrics for a first and a second party associated with an advertisement. This can be particularly applicable to advertisements in which the body of the advertisement is provided by a first party (e.g., a first advertiser) and a portion of the advertisement (e.g., a weather insert or live Twitter feed insert) is provided by a second party (e.g., a second advertiser).

The display metrics are preferably recorded in a display record for each piece of advertisement media. However, the display record can be for a given advertising schedule. When the display record is recorded by the processor, the processor can send the display record to the server at predetermined intervals (e.g., once a day, etc.), when a new advertising schedule is received, at the end of the advertisement campaign period, in response to a request from the server, or at any other suitable time.

Tracking display metrics can additionally include determining a payment amount for an advertisement and transferring payment for the advertisement from an advertiser payment account associated with the advertisement to a second payment account S500. Determining a payment amount preferably includes determining the payment amount based on the advertisement display record for the advertisement. For example, the payment amount can be determined based on the number of display instances for the advertisement, the duration of time that the advertisement was played, the number of people who passed by the advertisement or looked at the advertisement, the number of people satisfying the target demographic that passed by the advertisement or looked at the advertisement, or based on any other suitable display metric or any other suitable metric. Each display metric can be associated with a different payment rate, as determined based on the advertisement parameters (e.g., advertisement model). Transferring payment for the advertisement from the advertiser payment account to the second payment account preferably includes identifying the advertiser payment account associated with the advertisement, charging the advertiser payment amount, and transferring or distributing payment from the advertiser payment account to the second payment account. The second payment account is preferably the account of the billboard owner, but can alternatively be any other suitable account. One or more advertiser payment accounts can be identified for an advertisement. For example, when the advertisement body and a portion of the advertisement content are supplied by different advertisers or entities, the accounts corresponding to the different entities can be billed respectively. Transferring or distributing payment from the advertiser payment account can additionally include transferring or distributing a portion of the payment from the advertiser payment account or the billboard owner account to a third account, wherein the third account can be associated with the owners of the remote server system.

Facilitating billboard control through an application S400 functions to allow a user to take over the billboard displays for their own use. In operation, the billboard preferably displays advertisement media according to the advertising schedule until an application request is received from a user device. In response to receipt of the application control request S420, advertisement media play is preferably interrupted (e.g., paused), and billboard display control is switched or transferred to the application. The application request can be received at the server system or at the billboard processor. Advertisement media interruption can additionally require confirmation that the application identified within the application request is an application associated with the billboard or the account of the billboard owner (e.g., is an enabled application for the billboard). Advertisement media interruption can additionally require confirmation that the user is permitted to use the application. For example, each application can have an associated permissions list that lists the user accounts that can use the application and control the billboard. In another example, advertisement media playback can be interrupted in response to payment transfer from an account associated with the requesting user to the payment account of the billboard owner. The billboard preferably displays application media (e.g., media controlled by the application) until an application termination request is received from the user device S440. In response to receipt of the application termination request, advertisement media play is preferably resumed. The application termination request can be received at the server system or at the billboard processor. The advertisement termination request can be sent in response to a termination selection by the user at the user device, in response to the application shutting down or closing, in response to application inactivity (e.g., terminated after a threshold period of time), or in response to any other suitable termination event. The application termination request can be generated and sent by the user device, the server system, or the billboard processor. Advertisement media play can be resumed from the interruption point, from the next advertisement in the queue, from the next advertisement scheduled for a time after the substantially instantaneous time, or from any other suitable point in the advertising schedule.

Facilitating billboard control through an application S400 preferably includes interrupting scheduled advertisement media display S460 and directing control of the billboard to the application. Directing control of the billboard to the application can additionally include determining application media S470, controlling the billboard to display the application media S480, tracking billboard usage by the requesting user, and billing the user for billboard use.

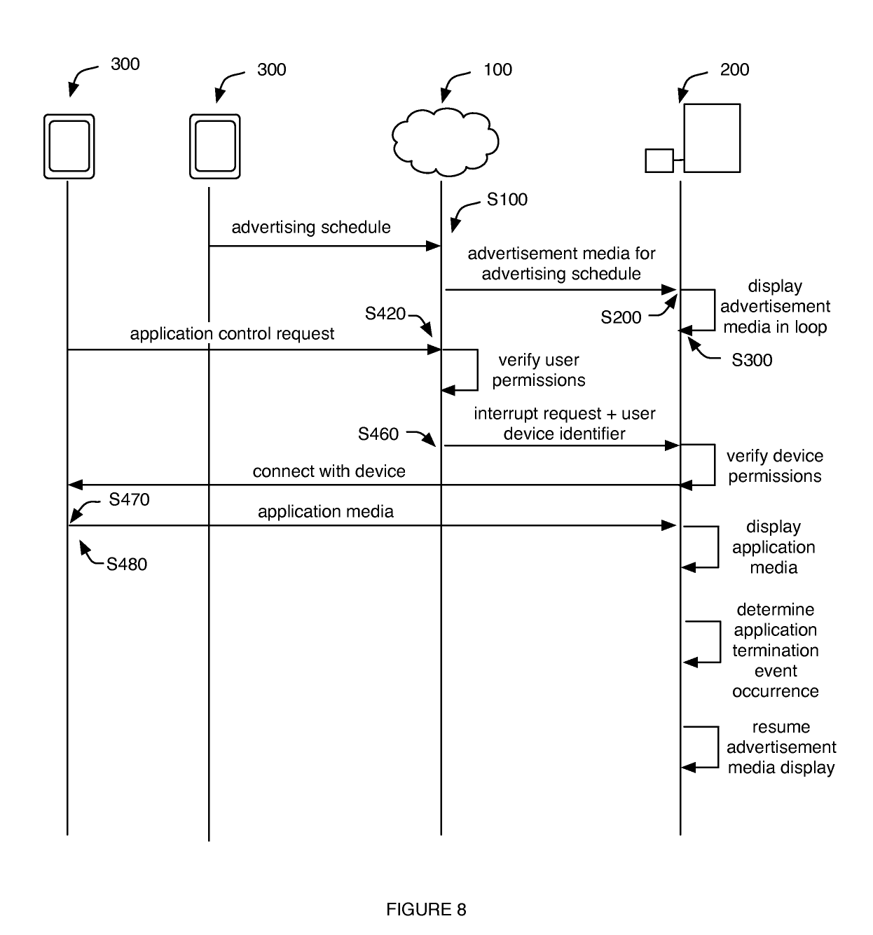

Interrupting scheduled advertisement media display S460 can include playing application media instead of advertisement media (e.g., when the advertisement media is streamed from the server to the billboard processor), as shown in FIG. 5. Interrupting scheduled advertisement media display can alternatively include sending an interrupt request to the billboard processor (e.g., as shown in FIGS. 6, 7, and 8) and pausing or shutting off advertisement display in response to receipt of the interrupt request (e.g., immediately or after the advertisement currently being shown ends), or include any other suitable method of interrupting advertisement media display at the billboard.

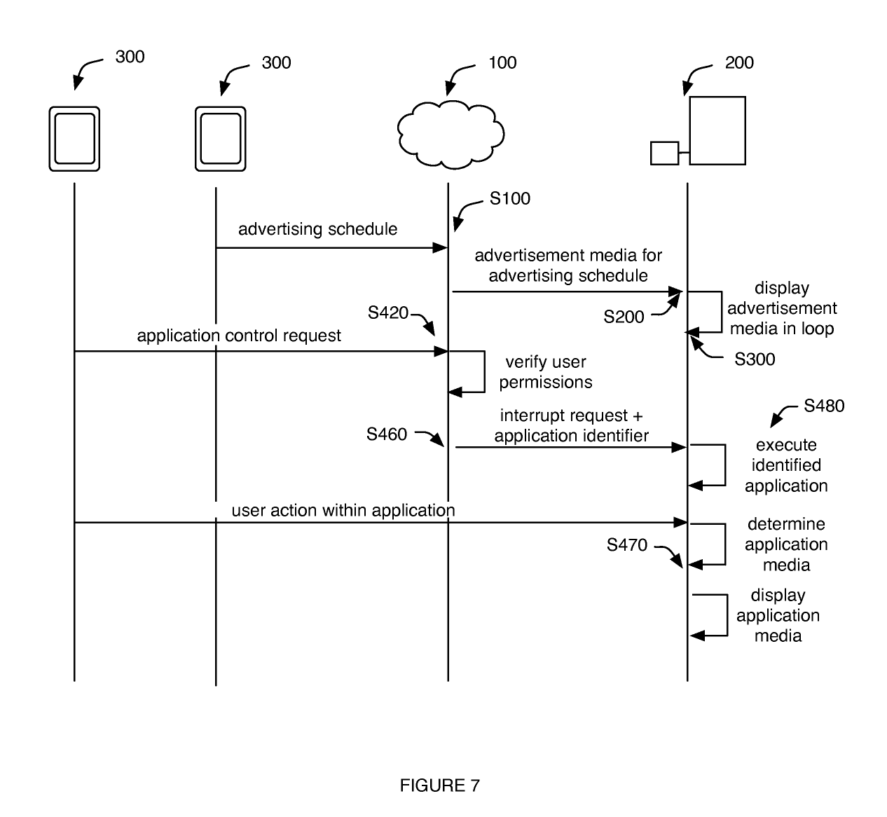

Determining the application media S470 functions to determine the application media for presentation on the billboard. The application media can be determined by the server system, as shown in FIG. 5 or by the billboard processor, as shown in FIGS. 7, 8, and 9. The application media is preferably media generated using instructions from an application. The application can be executed on a user device, wherein user actions (e.g., selections) are communicated to the server. The server then generates the application media based on the user actions within the application. Alternatively, the application can generate and send the application media to the server system, wherein the server system sends the application media to the billboard processor. Alternatively, the application is executed on the server (e.g., initiated in response to receipt of an application initiation request from a user device), wherein the user accesses the application on the server through the user device. For example, the application media can be a timer countdown, wherein the timer countdown functionality can be selected by a user through a user device. In another example, the application media can be a live audio and video stream from a user device, wherein the server receives the audio and video stream from the user device and transmits the audio and video stream to the billboard in response to initiation of a streaming application.

Controlling the billboard to display the application media S480 preferably includes identifying which billboard should be controlled by the application and facilitating application media display on the identified billboard. Identifying which billboard should be controlled by the application can include receiving a billboard selection from the user device (e.g., wherein billboards available for control to the user can be displayed to the user on the user device), automatically determining the billboard available to the user based on the user location (e.g., selecting a billboard proximal the user or within a given distance from the user), or a user location selection (e.g., the application request includes a selection of a mall, wherein the identified billboards are the billboards in the mall), or determined in any other suitable manner.

Identifying which billboard should be controlled by the application can additionally include verifying user permissions for the billboard and/or the application. For example, the user can use the application on the identified billboard if the user has permissions to use the application and the billboard. Verifying user permissions for the application can include verifying that the application is associated with the user account. Alternatively, verifying user permissions for the application can include verifying that the user account is on a permissions list associated with the application. Verifying user permissions for the billboard can include verifying that the user account is on a permissions list associated with the billboard. Verifying user permissions can additionally or alternatively include transferring payment from a payment account associated with the user account to a payment account associated with the billboard owner. Verifying user permissions can additionally or alternatively include determining user permissions based on historical application and/or billboard use by the user. For example, the user can have a monthly application or billboard use quota, wherein the user can be granted permission when the billboard or application usage records for the user indicate a usage level below the use quota, and can be denied permission when the usage level is above the use quota. However, user permissions for the billboard and the application can be otherwise verified. Facilitating application media display on the identified billboard can include streaming the application media instead of the advertising media to the billboard processor, sending the application media to the billboard processor concurrently or after the interrupt request is sent, switching billboard display control to the user device of the requesting user, or switching billboard display control to the billboard processor. Facilitating application media display can additionally include determining which billboard inputs are required by the application, and controlling the billboard processor to activate the required billboard inputs.

Tracking billboard usage by the requesting user or by the application functions to determine billboard usage metrics that can be subsequently used to bill the requesting user or user associated with the application. The billboard usage metrics are preferably tracked in substantially the same manner as the display metrics, as described above, but can alternatively be tracked in any other suitable manner. The billboard usage metrics are preferably stored in a billboard usage record within the server or the processor of the respective billboard. Billboard usage tracking is preferably triggered in response to directing control of the billboard to the application, but can alternatively be triggered by any other suitable event.

Tracking billboard usage by the requesting user can additionally include tracking application usage, wherein the application usage metrics can also be used to bill the requesting user. Application usage is preferably tracked in a similar manner as display metric tracking, but can alternatively be tracked in any other suitable manner. The application usage metrics are preferably stored in an application usage record within the server or the processor of the respective billboard. Tracking application usage can additionally include tracking application functionality usage, wherein the application can have different functionalities (e.g., different settings, etc.) and each functionality can have a different associated billing structure. Application usage tracking is preferably triggered in response to directing control of the billboard to the application, but can alternatively be triggered by any other suitable event.

Billing the user for billboard use functions to charge the user controlling the billboard. Billing the user for billboard use is preferably based on the billboard usage record and the billboard usage model. The billboard usage model is preferably assigned by the billboard owner, but can alternatively be automatically assigned or otherwise determined. The billboard usage model preferably associates a cost with a billboard usage measurement. For example, the billboard usage model can include a price for switching control of the billboard to an application, a price for a billboard use duration unit (e.g., price per minute of use), a price for use of a specific billboard input, a price for use of a specific combination of billboard inputs, or any other suitable price for any other suitable billboard use parameter. In another example, the billboard usage model can dynamically determine a price for billboard use based on the price that advertisers would pay or are paying to show advertisements in the same time slot for the given billboard. Billing the user preferably includes identifying a payment account associated with (e.g., owned by) the user and extracting the payment amount from the user account. The payment extracted from the user account is preferably transferred to the billboard or application owner account based on the application and/or billboard usage model. Alternatively, the payment can be extracted from the application owner account and transferred to the user or billboard owner account. The user account can be billed before billboard use, after billboard use, or before and after billboard use (e.g., wherein the user account is initially charged to gain permission to use the billboard, and charged after use based on the billboard usage records). Billing the user account can additionally include notifying the user with an estimate of the payment amount prior to switching control of the billboard to the application and allowing the user to select whether the system should proceed with switching billboard control to the application.

Billing the user for billboard use can include billing the user for application use. Billing the user for application use is preferably based on the application usage record and the application usage model. The application usage model is preferably assigned by the application owner (e.g., Twitter for a Twitter application), but can alternatively be assigned by the billboard owner, automatically assigned, or otherwise determined. The application usage model preferably associates a cost with an application usage measurement. For example, the application usage model can include a price for initiating the application, a price for an application use duration unit (e.g., price per minute of use), a price for use of a specific application functionality, a price for use of a specific package of application functionality, or any other suitable price for any other suitable application use parameter. The payment extracted from the user account is preferably transferred to the billboard or application owner account based on the application and/or billboard usage model. Alternatively, the payment can be extracted from the application owner account and transferred to the user or billboard owner account. The user account can be billed before application use, after application use, or before and after application use (e.g., wherein the user account is initially charged to gain permission to use the application, and charged after use based on the application usage records). Billing the user account can additionally include notifying the user with an estimate of the payment amount prior to switching control of the billboard to the application and allowing the user to select whether the system should proceed with switching billboard control to the application.

In one variation of the method as shown in FIG. 5, the server receives the application request from the user device, determines the billboards for which the user is requesting access (e.g., based on the application request, the user location, a user selection, or any other suitable information), and determines user permissions to the application and the requested billboards. In response to the user (or user account associated with the user device) satisfying the permissions requirements, the server executes the identified application on the server and interrupts scheduled advertisement playback by streaming application media instead of advertisement media or by sending an interrupt signal to the billboard processor. In response to a user selection or action within the application received from the user device at the server, the server preferably determines the instructions for the application (application instructions). The application instructions can include instructions for application media generation and/or display. The application instructions can additionally include billboard input instructions, such as which billboard inputs to activate, which billboard input measurements to collect, and instructions for application media generation based on the billboard input measurements. The server preferably generates the application media based on the application instructions in response to the received user actions, and sends the application media to the respective billboard processor for display.

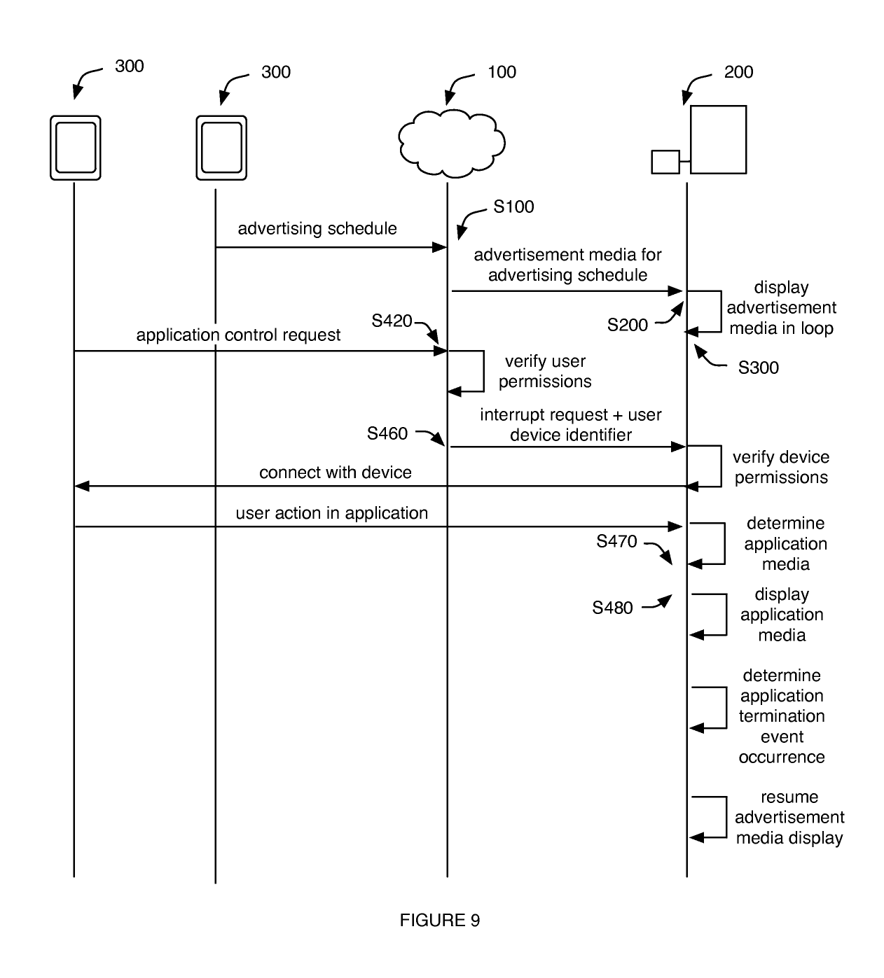

In another variation as shown in FIG. 9, the server receives the application request from the user device, determines the billboards for which the user is requesting access (e.g., based on the application request, the user location, a user selection, or any other suitable information), and determines user permissions to the application and the requested billboards. In response to the user (or user account associated with the user device) satisfying the permissions requirements, the server sends a playback interruption request and device connection information to the identified billboard. The device connection information preferably includes an identifier for the user device that sent the application request (device identifier). The device connection information can additionally include instructions for how to connect to the user device (e.g., permissions, passwords, communication technology, etc.). However, the device connection information can include any other suitable information. The user device can then connect to the billboard processor (e.g., wherein the associated device identifier is placed on a list of permitted devices based on the device connection information), or the billboard processor can connect to the user device based on the device connection information. The user device can then directly communicate with and control the billboard. The application media is preferably generated by the user device and sent to the billboard processor, but the application media can alternatively be generated by the billboard processor in response to receipt of a user selection or other action within the coupled application (e.g., wherein the application is executed on the billboard processor). The billboard then displays the application media.

In one example of application control of the billboard, a user associated with a user account and a user device can open a trainer application on the user device. In response to execution of the trainer application, the user device sends an application request identifying the trainer application to the server system. In response to receipt of the application request, the server system determines the billboards associated with the user account, determines the billboard owner account for the identified billboards, verifies that the trainer app is associated with the billboard owner account, sends an interrupt request to the identified billboards, and initiates a complimentary application to the trainer application. In response to receipt of the interrupt request, the billboards preferably cease advertisement media playback. In response to a user selection at the device (e.g., selection of a countdown timer), the server selects or generates the corresponding application media based on the selection (e.g., a video of a countdown timer) and sends the application media to the billboards for display. The billboards preferably display the received application media (e.g., the video of the countdown timer). In response to an application termination request received from the user device at the server system, the server system can send a resume request to the billboards, send the advertisement media to the billboards, or otherwise resume advertisement media playback.

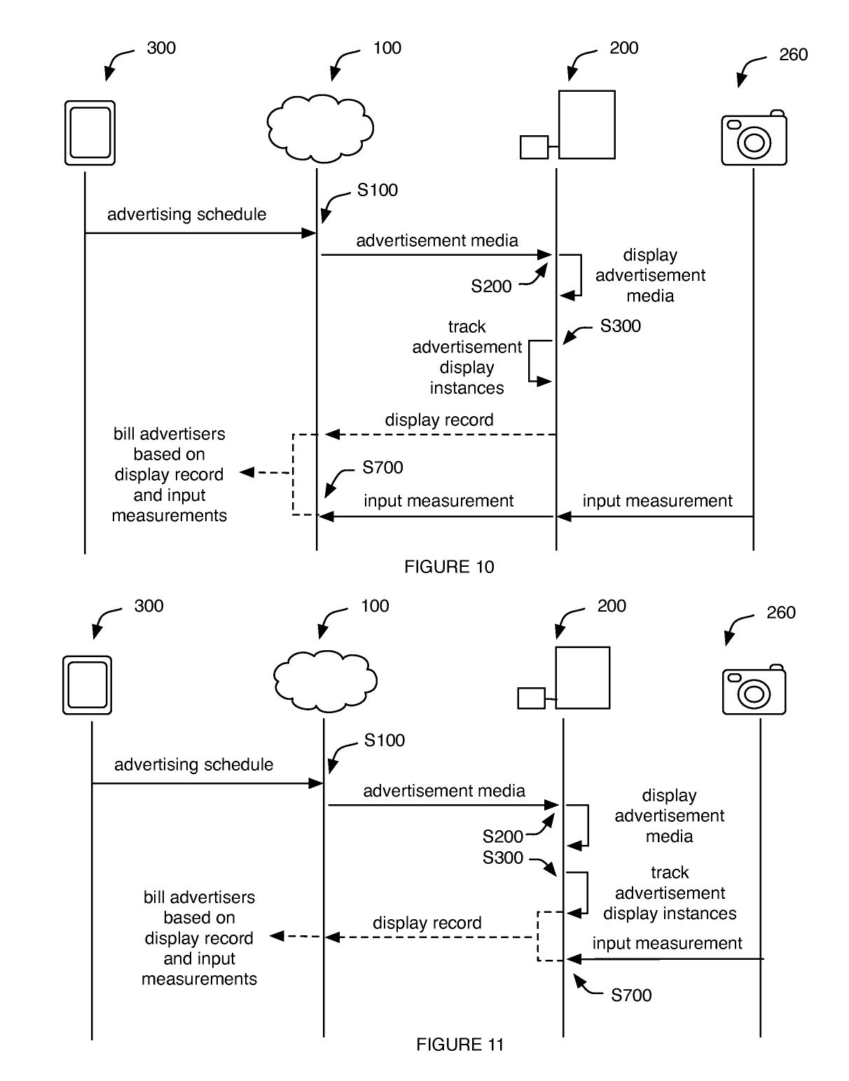

As shown in FIGS. 10 and 11, the method can additionally include receiving billboard input measurements S700 and processing the input measurements. The input measurements can be processed to extract conversion metrics, inputs for advertisement generation, inputs for recommendation generation, inputs for analysis generation, or any other suitable data point. The raw (e.g., unprocessed) input measurements are preferably recorded at the billboard processor and sent to the server, wherein the server preferably processes the input measurements to extract the desired information. Alternatively, the processor can partially process the input measurements to reduce the amount of data to be sent to the server (e.g., by averaging the measurements, calculating a metric from multiple inputs, etc.). Alternatively, the processor can process the input measurements to extract the desired information, and send the extracted information to the server. The billboard input measurements can be processed using blob detection, feature identification (e.g., eye identification, license plate identification, etc.), scene classification, object classification, image segmentation, face detection, focal analysis, region clustering, graph segmentation, gradient analysis, or any other suitable image or data processing techniques.

The method can additionally include dynamically adjusting the billboard usage model or the advertisement model based on billboard input measurements. The billboard usage model or advertisement model is preferably adjusted by the server system, but can alternatively be adjusted by the billboard processor, wherein the billboard processor stores and determines the billboard usage model or advertisement model. For example, the billboard usage model can bill advertisements or users for billboard use at a first rate for traffic below a first threshold level (e.g., as determined from a camera) and bill advertisements or billboard use at a second rate for traffic above the first threshold level. In another example, a first amount can be charged for advertisement viewers (e.g., as determined from image processing of images captured by the camera) that are within the target demographic, and a second amount can be charged for advertisement viewers that are outside the target demographic.

The method can additionally include dynamically adjusting advertisement media or the advertising schedule based on billboard input measurements. The advertisement media or advertising schedule is preferably dynamically adjusted by the processor, but can alternatively be adjusted by the server in response to receipt of the input measurements. For example, the processor can dynamically select which advertisement to display or dynamically generate the advertisement media based on the billboard input measurements. For example, the method can select a first advertisement sequence in response to the number of people passing by the billboard falling below a threshold level, and select a second advertisement sequence in response to the number of people passing by the billboard surpassing the threshold level. In another example, the method can generate an advertisement based on the characteristics of a person in front of the billboard, based on the billboard inputs and/or information retrieved from third party sources. In another example, the method can select an advertisement based on the RFID tags of the credit cards proximal the person near the billboard. In another example, in response to detection of a target demographic or other advertisement parameter exceeding a threshold frequency, the advertising schedule can be adjusted to increase the display frequency of advertisements having the target parameter, to introduce advertisements having the target parameter (e.g., that were not part of previously scheduled advertisements), or adjusted in any other suitable manner.

The method can additionally include dynamically adjusting the advertisement media or advertising schedule for a second billboard based on input measurements collected at a first billboard. For example, in response to detection of the same entity appearing in the images captured by two billboards spaced a given distance apart (e.g., several feet, several miles, etc.), the direction of entity travel can be estimated, and the advertising schedule for a third billboard along the direction of entity travel can be adjusted to continue a series of advertisements that were shown in the first two billboards, to target the entity (e.g., based on which billboard advertisements the entity looked at), or adjusted in any other suitable manner.

The method can additionally include aggregating billboard input measurements over a period of time to generate campaign summaries or recommendations. The campaign summaries or recommendations can additionally be generated from billboard input measurements aggregated over a plurality of billboards. Generating campaign summaries can include analyzing input measurements to extract conversion information. For example, a conversion rate can be determined by matching the people who walked by a first billboard while a first advertisement was playing at a first time with the people who walked into the store advertised by the first advertisement, as determined through images captured by a second billboard located proximal the store, at a second time after the first time. Generating recommendations can include analyzing the parameters of advertisement media associated with high numbers of views (e.g., as determined from the billboard input measurements) or other metrics of high conversion rates and extracting parameters shared between the advertisement media. Examples of recommendations that can be extracted include media recommendations (e.g., brightness, color, audio), location recommendations (e.g., which specific billboards to advertise on), time recommendations, advertising duration recommendations, or any other suitable advertisement parameter recommendation. Summarizing the input measurements for each billboard can additionally permit advertisers to search and select the individual billboards to display advertisements on.

The method can additionally include sending notifications. A notification can be sent in response to switching billboard control from the advertising schedule to the user or application, in response to switching billboard control from the user or application to the advertising schedule, or in response to any other suitable control or scheduling change event. A notification can also be sent in response to the price for billboard use dropping below a threshold level, the price for application use dropping below a threshold level, or in response to any other suitable pricing change. The notification is preferably sent to the billboard owner, but can alternatively be sent to the user or the advertiser.

An alternative embodiment preferably implements the above methods in a computer-readable medium storing computer-readable instructions. The instructions are preferably executed by computer-executable components preferably integrated with a communication routing system. The communication routing system can include an advertisement generation system, an advertisement scheduling system, and a billboard control system that controls billboard operation between advertisement display and application display. The computer-readable medium may be stored on any suitable computer readable media such as RAMs, ROMs, flash memory, EEPROMs, optical devices (CD or DVD), hard drives, floppy drives, or any suitable device. The computer-executable component is preferably a processor but the instructions may alternatively or additionally be executed by any suitable dedicated hardware device.

As a person skilled in the art will recognize from the previous detailed description and from the figures and claims, modifications and changes can be made to the preferred embodiments of the invention without departing from the scope of this invention defined in the following claims.

We claim:

1. A method for scheduling content for a digital billboard, comprising:
receiving an advertisement schedule from a first user account, the schedule comprising advertisement media;
identifying a billboard identifier associated with the user account, the billboard identifier associated with the billboard;
controlling the billboard to display the advertisement media according to the advertisement schedule; and
in response to receipt of an application request for the billboard from a user device, the application request identifying an application associated with the user account, interrupting advertisement media display and directing control of the billboard to the application.

2. The method of claim 1, further comprising recording display instances of the advertisement media.

3. The method of claim 2, wherein recording display instances of the advertisement media comprises recording display instances of the advertisement media at a processor of the billboard.

4. The method of claim 2, further comprising transferring payment from an advertising account associated with the advertisement media to a payment account associated with the user account based on the recorded display instances of the advertisement media.

5. The method of claim 1, wherein controlling the billboard to display the advertisement media comprises determining the advertisement media at the remote server and sending the advertisement media to a processor of the billboard.

6. The method of claim 5, wherein the advertisement media comprises video.

7. The method of claim 5, further comprising:
receiving a set of advertisement instructions from a user;
retrieving near-real time information from a remote server based on the advertisement instructions; and
automatically generating advertisement media based on the near real-time information, wherein controlling the billboard to display the advertisement media comprises controlling the billboard to display the automatically generated advertisement media.

8. The method of claim 5, further comprising controlling advertisement media display according to the schedule by the processor.

9. The method of claim 1, wherein directing control of the billboard to the application comprises: determining application media at the remote server and controlling the billboard to display the application media.

10. The method of claim 9, further comprising:
receiving a selection within the application from the user device;
determining application media associated with the selection; and
sending the determined application media to the processor for display on the billboard.

11. The method of claim 9, further comprising:
recording application usage for each user device; and
transferring payment from a second user account associated with the user device to a payment account associated with the first user account.

12. The method of claim 9, further comprising: verifying permission for a second user account associated with the user device to use the application.

13. The method of claim 12, wherein verifying permission for the second user account to use the application comprises verifying that the account has satisfied a billing requirement.

14. The method of claim 9, wherein recording application usage is triggered in response to directing control of the billboard to the application.

15. The method of claim 1, further comprising: in response to receipt of an application termination request from the user device, controlling the billboard to display the scheduled advertisement media.

16. The method of claim 15, wherein controlling the billboard to display the scheduled advertisement media comprises controlling the billboard to display advertisement media scheduled for a time after an application termination request receipt time.

17. The method of claim 1, further comprising:
receiving visual inputs recorded by a visual input device of the billboard at the remote server;
determining an advertisement exposure rate by processing the visual inputs; and
dynamically adjusting the schedule of advertisement media based on the advertisement exposure rate and an advertisement model associated with the advertisement media.

18. A method for scheduling advertisement media, comprising:
receiving an advertisement application purchase request from a user device;
storing the advertisement application in association with a user account associated with the user device;
receiving a first usage model for the advertisement application associated with a first advertiser account;
receiving a time assignment for the advertisement application within a schedule;
receiving a first advertisement media from the user device;
receiving a second usage model for the first advertisement media associated with a second advertiser account;
receiving a time assignment for the first advertisement media within the schedule;
in response to a substantially instantaneous time coinciding with the time assignment for the scheduled advertisement application within a threshold time duration, generating second advertisement media based on near real-time data retrieved from a third party source accessed through the advertisement application;
sending the first advertisement media, the second advertisement media, and the respective time assignments to a processor controlling a digital billboard for display on the digital billboard;
receiving a first record of display instances of the first advertisement media and a second record of display instances of the second advertisement media;
transferring a first payment from the first advertiser account to a payment account associated with the user account, the first payment based on the first record and first usage model; and
transferring a second payment from the second advertiser account to the payment account, the second payment based on the second record and second usage model.

19. The method of claim 18, wherein the advertisement media comprises stored media and a second advertisement application, the method further comprising updating the advertisement media with near real-time data retrieved from a second third party source accessed through the second advertisement application in response to the substantially instantaneous time coinciding with the time assignment of the advertisement media within a threshold time duration.

20. The method of claim 19, wherein transferring a first payment from the first advertiser account to the payment account based on the first record and first usage model further comprises transferring a third payment from the first advertiser account to a third account associated with the second advertisement application, the third payment based on the first record.
